(19) United States
(12) Patent Application Publication
(10) Pub. No.: US 2005/0230161 A1
(43) Pub. Date: Oct. 20, 2005

(54) Traveling body using automatic inertia traveling apparatus

(76) Inventor: Shoichi Terui, Kitaue-si Iwateken (JP)

Correspondence Address: ROTH & GOLDMAN, P.A., 523 W. 6TH STREET, SUITE 707, LOS ANGELES, CA, 90014, US

(21) Appl. No.: 10/524,579

(22) PCT Filed: Aug. 19, 2003
(86) PCT No.: PCT/JP03/10429

§ 371 Date: Feb. 15, 2005

(30) Foreign Application Priority Data
Aug. 19, 2002 (JP) 2002-293078
Aug. 19, 2003 (JP) 2003-346318

(51) Int. Cl. B60K 1/00

(52) U.S. Cl. 180/65.3

(57) ABSTRACT

A traveling body (motor vehicle, ship) using an automatic inertia traveling apparatus is provided with a feedback control where a traveling body speed is a feedback amount. The traveling body is accelerated by controlling a fuel-regulating mechanism of an engine in accordance with a traveling body speed deviation. When the speed of the traveling body reaches a target traveling body speed, an electromagnetic clutch is disengaged and the engine is made the transition.

### BACKGROUND OF THE INVENTION

1. Field of the Invention

The present invention relates to an apparatus for a running vehicle capable of achieving a very efficient engine system in such a manner that a fuel supply is stopped when a vehicle runs within a desired speed range using an inertia force of a structure using various engines (gasoline engine, diesel engine, hybrid engine, fuel cell, etc.) adapted to a vehicle, ship, bike, bicycle, etc. When a vehicle runs in a speed range below a desired speed, a fuel is supplied for thereby increasing a speed based on a feedback control.

2. Description of the Background Art

As related conventional arts concerning the inertia running device for a vehicle, there are Japanese patent application Hei 3-62753, Japanese patent application No. Hei 5-37242, Japanese patent application No. Hei 5-65885, and Japanese patent application Hei 5-145339. However, since there is not any technique concerning a feedback control mechanism capable of changing a speed to a feed back speed, the above conventional arts have not been practically adapted in the industrial field.

### SUMMARY OF THE INVENTION

Accordingly, it is an object of the present invention to provide a vehicle having an automatic inertia running device that is characterized in that a speed is set using an accelerator pedal, and a speed of a running vehicle is fed back to a certain detection object of a generator or a rotation tranducer and is compared in a set speed-detection speed comparator, and a fuel adjusting unit is operated based on a difference of the comparison, and a fuel increase and decrease of the engine is controlled, and an acceleration is achieved, and after a destination speed is reached, an electrode clutch is separated, and the operation mode is changed to an idling mode, and in the case that a speed is decreased below a permission difference degree of the destination speed, an electrode clutch is connected, and the idling mode is stopped, and the operation mode is changed to a set speed-detection comparison operation.

### BRIEF DESCRIPTION OF THE DRAWINGS

The preferred embodiments of the present invention will be described with reference to the accompanying drawings.

FIG. 1 is a block diagram of a first example of an automatic inertia running device according to the present invention;

FIG. 2 is a view of a first example of an output characteristic of a fuel adjusting unit according to the present invention;

FIG. 3 is a view of a first example of a speed characteristic of an accelerator pedal and a brake pedal according to the present invention;

FIG. 4 is a view of a first example of a vehicle speed characteristic according to the present invention;

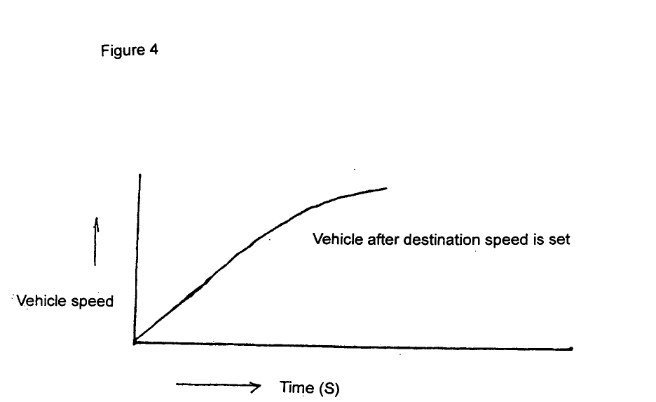

FIG. 5 is a block diagram of a first example of an engine acceleration-based automatic inertia running apparatus (hereinafter referred to E-S UPS) before an E-S connection according to the present invention;

FIG. 6 is a view of a first embodiment of a characteristic of a speed-accelerator pedal and a characteristic of a brake pedal of an E-S UPS according to the present invention;

FIG. 7 is a view of a first example of a characteristic of a speed-control process of an E-S UPS according to the present invention;

FIG. 8 is a block diagram of a first example of an ES UPS and a low speed motor according to the present invention; and

FIG. 9 is a view of a first example of a characteristic of a speed-control process for an ES UPS and a low speed motor according to the present invention.

Descriptions of reference numerals concerning major parts of drawings

| | |
|---|---|
| 1, 31: accelerator pedal | 2, 32: brake pedal |
| 3, 33: clutch pedal | 4, 36: adder subtractor |
| 5: idling command unit | 6: fuel adjusting unit |
| 9: clutch | 10, 44: electronic clutch |
| 11, 41, 47: generator or rotation | |
| tranducer | |
| 12, 40, 46: revolution converter | 13, 42: engine |
| 14, 51: inclination sensor | 15: hydraulic pipe |
| 38: positioner | 39: fuel adjusting mechanism |
| 16, 45: brake | 52: low speed motor |
| 17: wheel (tire) | 53: opening and closing |
| | mechanism |
| 18: idling converter | 54: battery |
| 19: clutch converter | 20: shaft |
| 21, 43: transmission box | 49: E-S connection comparator |
| 50: quick acceleration sensor | 22, 31: magnifier or magnification |
| | mechanism |
| S1˜S4: switches | E: engine side |
| Swa: contact point (always closed) | S: shaft side |
| OR1˜OR5: OR-gate circuit | AND: AND-gate circuit |
| C1˜C6: flip-flop circuit | |

### DETAILED DESCRIPTION OF THE PREFERRED EMBODIMENTS

In a common fuel engine, since there is a compression process, it is needed to maintain a certain revolution, and a certain amount of fuel is needed as much as an engine brake. In the present invention, a destination speed is set based on an accelerator pedal, etc. When a detected speed is in a range of a destination speed, a clutch is automatically disconnected, so that an engine rotates in an idle mode. Therefore, it is possible to significantly decrease the consumption of fuel.

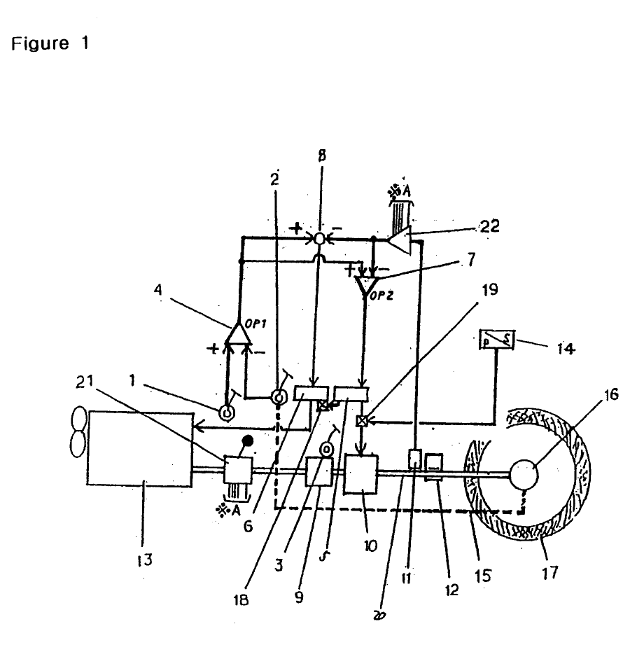

As shown in FIG. 1, the following construction is basically needed for maintaining a desired destination speed.

A destination speed is set using an accelerator pedal 1 at a first stage and is inputted into a set speed-detection speed comparator 8.

The revolution is inputted into the set speed-detection speed comparator 8 at a feed back speed of minus value. When the difference between the set speeds is plus, the output is plus value, and the revolution of the wheel is inputted into a fuel adjusting unit 6, so that the amount of fuel supply of an engine 13 is increased.

The speed detection of a ship is detected for the use of ship.

When the feeding back speed of the minus value of the shaft revolution is above a set speed, the output of an additional adder and subtractor 7 becomes minus value, so that an electronic clutch 10 is automatically separated and is inputted into an idling converter 18 for thereby performing an idling operation. The speed gets slower due to wind pressure, and friction force of vehicle. When the speed becomes below a permissible difference level (ΔS), the output of the set speed-detection speed comparator 8 becomes plus value, so that the electronic clutch 10 is connected, and the supply of fuel is increased, whereby the speed of a running object is accelerated. The connection of the electronic clutch 10 enables the revolution of the engine to be similar with the destination set speed. When it is needed to slow down the speed for a certain reason, the brake pedal 2 is stepped, and the brake 16 is applied to the vehicle through a hydraulic pipe 15, and the adder and subtractor 4 computes the set speed, so that a new low speed is set.

When a vehicle runs a downhill, an engine brake is used. In this case, the inclination sensor 14 is operated, and the clutch converter 19 is operated, so that the electronic clutch 10 is connected with an engine side 13 and a vehicle side 17, whereby the engine brake first operates.

The switch between high speed, middle speed, low speed and rear operation is set using the transmission box using a conversion gear. The magnification of the magnifier is automatically converted. When the feed back speed is set 1, low speed, from the gear position of the transmission box, assuming that the feedback speed to the middle speed is NM, the magnifier is automatically set 1/NM. Even when the revolution of the engine is same, the unbalance of the feed back system is overcome based on the differences between the low speed, middle speed and feed back speed. Therefore, it is possible to achieve a normal operation of the vehicle.

Here, the electronic clutch represents a typical electronic clutch such as hydraulic, fluid or fluid joint.

Claim 1 cites the vehicle having an automatic inertia running apparatus.

The vehicle represents all kinds of vehicles having clutch or transmission box without clutch.

In FIG. 1, *A represents a state that there are four levels of low speed, middle speed, high speed and rear operation. There are four lines. Another one is common. Even when the revolutions of the engine are same, the differences of the feed back speed due to the difference of the transmission ratio are matched with respect to the revolution of the engine by connecting the transmission box 21 and the magnifier 22. Even when the gear is positioned at a certain portion, the feed back control is achieved.

Here, the set speed represents a speed set with an accelerator. The detection speed represents a speed that the speed is detected using a generator and is changed to the feed back speed. The fuel adjusting mechanism represents a fuel adjusting unit 6 and a fuel adjusting structure of the engine.

Claim 2 cites an interlock by the clutch converter 19 so that the engine brake should be operated at the downhill.

Claim 3 cites a jet ski, a ship, a vehicle using fuel cells and a hybrid vehicle.

In the ship, in the case of wheels 17, an accelerator 1, a brake 2, an inclination sensor 14, etc., the name of the vehicle 17 is changed to a propeller, and it is no need to change the name of the inclination sensor 14. The accelerator 1 and brake are changed to a speed setting unit 1 and a decelerator 2.

In addition, a speed detection method is for the ship.

Claim 4 cites a system for matching the revolution of the engine with the revolution of the shaft before the connection, wherein an acceleration is needed by connecting the engine with the shaft in the case that the speed is decreased below a permitted range.

Claim 5 cites the construction that the speed gets slower after the idling operation of claim 4 is performed, so that the speed decrease is prevented using the low speed motor 52.

Claim 6 cites a structure of controlling a driving force transfer in a driving force transfer system between an engine of a transmission box and a vehicle. It does not simply represents a clutch.

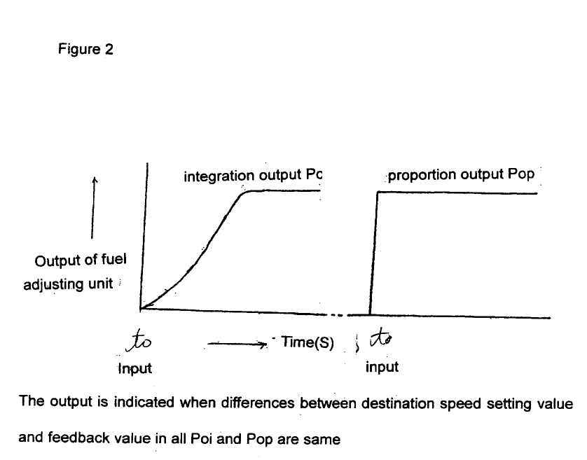

As shown in FIG. 2, there is shown an output state of a fuel adjusting unit in the case that the set value of the destination speed is the same as the feedback speed value.

In the above construction, the output with respect to time is classified into an output related to proportion (Pop) and an output related to integration (Poi).

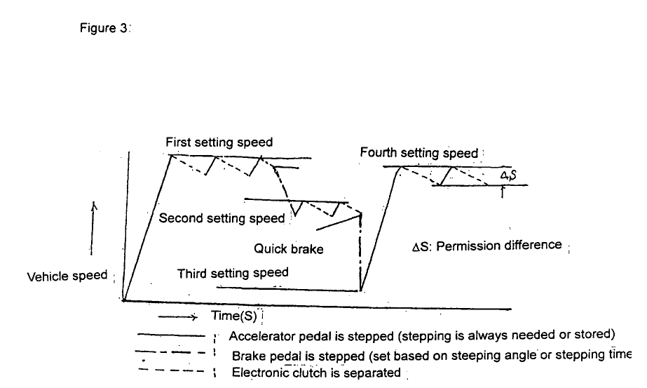

As shown in FIG. 3, when the speed is increased by stepping the accelerator 1, the destination speed value is set, but the set value is classified into a value stored based on the stepping angle, and a value set only when the accelerator is stepped.

In the later case, when the foot is removed, the set speed is sharply decreased. In addition, after the detection speed has reached the set speed, the electronic clutch 10 is separated, and the operation mode is changed to an idle mode (first setting speed). When the speed got slow down below the permission difference level (ΔS), the acceleration is started, and the speed is decreased down to the first set speed. The above method is repeatedly performed, so that the automatic operation having a change of the permission difference level (ΔS) is performed.

In the above state, when the brake 2 is stepped, the set speed is decreased based on the stepping angle, so that a new second speed is set. The degree of the subtraction is most effective when two factors of the stepping angle and time are adapted.

In the quick brake, the acceleration speed is set using the accelerator after the third set speed is indicated, so that a new fourth set speed is set.

In the running vehicle according to the present invention, the fuel consumption ratio is decreased by 20˜35% as compared to the conventional running vehicle. Therefore, it is possible to obtain a big energy saving effect, and the warming phenomenon and pollution problem of the atmosphere due to the vehicles can be significantly decreased.

As the kinds of signals that indicate the amount of information used in the feedback control system, there are levels of DC and AC or high and low levels of frequencies or digital signals.

The adder and subtractor 7 has two set values of which one value is an upper limit set value set by the accelerator 1, and the other value is a lower limit set value based on a speed slow down in the idling operation mode.

Generally, the lower limit value is automatically set after the upper limit set value is set.

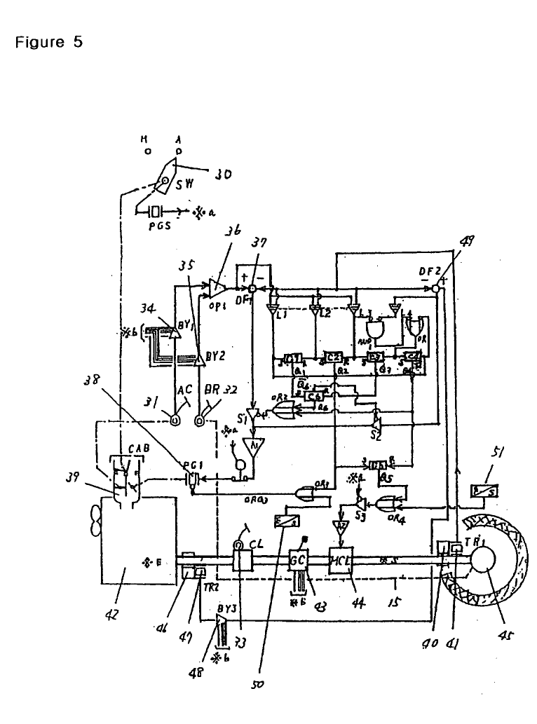

In the above state, when the set speed is above the feedback speed of minus value, and the speed gets slower in the idling operation mode, and then the speed becomes near the lower limit set speed, it is needed to increase the revolution of the engine to the operation speed in the idling mode. FIG. 5 is a view illustrating one method of the above operation.

As shown in FIG. 5, when the accelerator pedal 81 is stepped, the magnification of the magnifier 34 is converted based on the transmission ratio of the transmission box 43 and is inputted into the adder and subtractor 36. The revolution of the shaft is fed back to the comparator 37. The difference becomes the output DF1, and a deceleration command is outputted from the detector L1 and is outputted from the flip-flop C1 to Q1. The value is inputted from Q5 to the OR-gate OR2 and is inputted to the switch S1.

The output DF1 is amplified by the amplifier A1 through the switch S1 for thereby operating the positioner 38, and the opening degree of the value of the fuel adjusting unit 39 is controlled for thereby achieving an acceleration of the vehicle. When the acceleration is performed, and the speed reaches the set speed. The value is divided into the engine side E and the shaft side S by the electronic clutch 44, and the inertia running command is outputted by the detector L2, and the operation mode is changed to the idling mode.

When the speed of the vehicle gets slow down due to the resistances by the shaft, wind pressure, etc., the lower limit speed is detected by the detector L3, and the revolutions of the shaft S and the engine E are compared in the E-S connection comparator 49 in the idling mode. The difference of the comparison becomes the output DF2 and is amplified by the amplifier A1 through the switch S2. The difference is used for adjusting the opening degree of the value of the fuel adjusting mechanism 39, so that the acceleration and deceleration of the vehicle are adjusted.

When the revolutions of the engine E and the shaft S are matched, the -detector L4 detects the matching state, and an E-S connection command is outputted, and the electronic clutch 44 is connected.

The constructions concerning the mechanism are shown in FIG. 5.

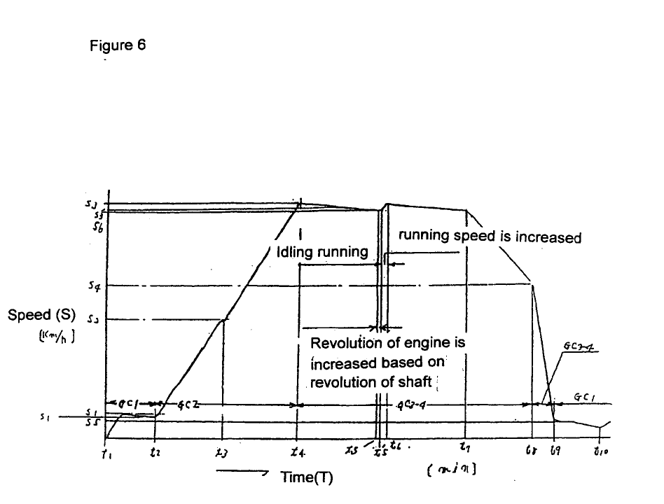

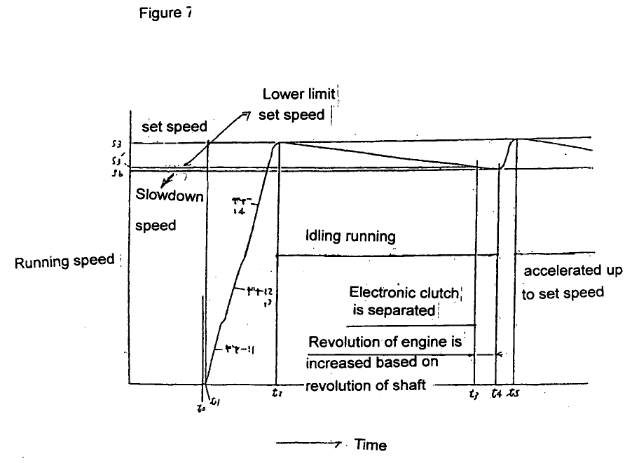

FIG. 6 is a view of the controller and speed and time of FIG. 5, and FIG. 7 is a view of the detailed constructions of the controller and speed of FIG. 5.

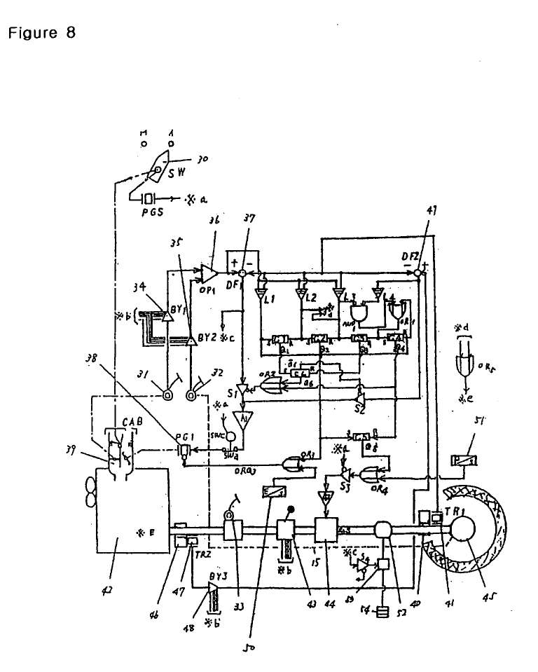

FIG. 8 is a view illustrating a mechanism that the decrease of the speed in the idling mode is controlled in detail by the low speed motor 52.

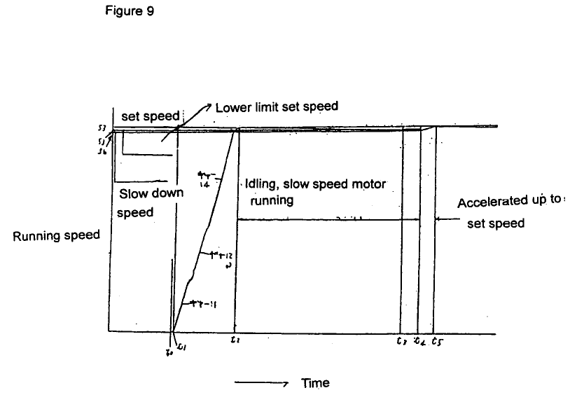

As shown in FIG. 9, the low speed motor 52 is operated in the idling mode, and the output of the low speed motor corresponds to ⅕˜ 1/10 of the engine output.

Others are the mechanisms like 0017, 0018, 0020 and 0021.

In the present invention, an electric circuit is used for a control operation. An IC construction is preferably used. A plurality of ICs are used for thereby comparing a detection value and an output value for thereby detecting an error of the electric circuit.

The present invention may be well adapted to a compression process.

It is possible to significantly enhance the rate of fuel consumption for a small load with respect to a generator having a large driving force load.

The present invention may be adapted to a winding apparatus or a crane, and the application range of the present invention is wide.

In the case that the present invention is adapted to a generator, etc., since it is needed to drive the generator at a constant revolution, a speed converter is needed.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A vehicle having an automatic inertia running device that is characterized in that a speed is set using an accelerator pedal 1, and a speed of a running object (vehicle) is fed back to a certain detection object of a generator or a rotation tranducer 11 and is compared in a set speed-detection speed comparator 8, and a fuel adjusting unit 6 is operated based on a difference of the comparison, and a fuel increase and decrease of the engine 13 is controlled, and an acceleration is achieved, and after a destination speed is reached, an electrode clutch 10 is separated, and the operation mode is changed to an idling mode, and in the case that a speed is decreased below a permission difference degree of the destination speed, an/electrode clutch 10 is connected, and the idling mode is stopped, and the operation mode is changed to a set speed-detection comparison operation.

2. The vehicle of claim 1, wherein in the case that an inclination sensor 14 detects a downhill during an operation based on the automatic inertia running apparatus, the electronic clutch 10 is automatically connected for thereby using an engine brake effect even in an inertia running operation mode.

3. A vehicle or a ship having an automatic inertia running device that is characterized in that a speed is set using a speed setting unit 1, and a speed of a running vehicle is fed back to a speed detector of a generator and is compared in a set speed-detection speed comparator 8, and a fuel adjusting unit 6 is operated based on a difference of the comparison, and a fuel increase and decrease mechanism of the engine or fuel cell is controlled, and an acceleration is achieved, and after a destination speed is reached, an electronic clutch is separated, and the operation mode is changed to an idling mode, and in the case that a speed is decreased below a permission difference degree of the destination speed, an electronic clutch 10 is connected, and the idling mode is stopped, and the operation mode is changed to a set speed-detection comparison operation.

4. A vehicle having an automatic inertia running apparatus that is characterized in that a speed is set using an accelerator pedal 31, and a speed of a running vehicle is fed back to other detection units such as a generator or a rotation tranducer 41 and is compared in a set speed-detection speed comparator, and a positioner for a fuel adjustment is adjusted based on a difference of the comparison, and a speed of vehicle is increased or decreased, and after a destination speed is reached, an electronic clutch 44 is separated, and the operation mode is changed to an idling operation, and in the case that a speed is decreased below a destination speed, a revolution of an engine E is adjusted so that a revolution of a shaft S is adjusted and summed, and thereafter an engine side E and a shaft side S are connected, and a vehicle speed is increased to a destination speed, and the above operations are repeatedly performed.

5. The vehicle of claim 4, wherein after a destination speed is reached, a slow speed motor 52 is operated in an idle mode for thereby minimizing a decrease of a vehicle speed.

6. The vehicle of one among claims 1 through 5, wherein a driving force transfer system between a transmission box or an engine and a vehicle has a function of controlling a driving force that corresponds to an operation of the electronic clutch 10.

7. A power generation facility having an engine with a compression process that is characterized in that an inertia force is enhanced using a generator or a vehicle having a big difference, and the operation mode is changed to an idling operation mode after the speed is increased above a static revolution of a generator and reaches at a destination speed, so that an efficiency at the time of a small load is enhanced, wherein a speed converter is used in order to maintain a static speed.
